(19) United States
(12) Patent Application Publication
(10) Pub. No.: US 2025/0272722 A1
(43) Pub. Date: Aug. 28, 2025

(54) SYSTEMS AND METHODS FOR AUTHENTICATING DATA

(71) Applicant: Capital One Services, LLC, McLean, VA (US)

(72) Inventors: Armando MARTINEZ STONE, Arlington, VA (US); Ashleigh CHOI, Arlington, VA (US); Bryant YEE, Silver Spring, MD (US)

(73) Assignee: Capital One Services, LLC, McLean, VA (US)

(21) Appl. No.: 18/590,328

(22) Filed: Feb. 28, 2024

(51) Int. Cl. G06Q 30/0282

(52) U.S. Cl. CPC G06Q 30/0282

(57) ABSTRACT

Disclosed is a method that may include receiving, at a remote device, a detection by a first electronic application operating on a user device, an interaction between a user of the user device and an entity via a second electronic application. The method may include determining that the interaction between the user and the entity is reviewable based on first interaction data. Upon determining that the interaction between the user and the entity is reviewable, the method may further include causing the first electronic application to prompt the user to enter second interaction data including a user review of the entity associated with the detected interaction. The method may include determining that the user review of the entity is authentic based on a classification model, the first interaction data and the second interaction data being input to the classification model.

### TECHNICAL FIELD

Various embodiments of the present disclosure relate generally to systems and methods for authenticating data.

### BACKGROUND

Users often use on-line review providers to determine if, for example, they would like to purchase a product or visit a merchant, such as a restaurant, store, or other provider of goods or services. For reviews to be meaningful and valuable, users must perceive them to be trustworthy. Generally, a user may find a review more trustworthy when it is confirmed that the review is authentic. In addition, reviews are most valuable when there is a robust number of reviews. As such, a need exists for providing systems and methods for generating a robust number of reviews and providing authenticity to the reviews.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for authenticating data are described.

In some aspects, the techniques described herein relate to a computer-implemented method, including: receiving, at a remote device, a detection by a first electronic application operating on a user device of an interaction between a user of the user device and an entity via a second electronic application; determining that the interaction between the user and the entity is reviewable based on first interaction data; upon determining that the interaction between the user and the entity is reviewable, causing the first electronic application to prompt the user to enter second interaction data including a user review of the entity associated with the detected interaction; receiving, at the remote device and from the user device, the second interaction data including the user review of the entity; determining that the user review of the entity is authentic based on a classification model, the first interaction data and the second interaction data being input to the classification model; upon determining that the user review of the entity is authentic, storing, by the remote device, the user review in a data storage associated with the entity.

In some aspects, the techniques described herein relate to a computer-implemented method, including: receiving, at a remote device from a first electronic application, first interaction data associated with a user and an entity, the first interaction data including a user review of the entity; retrieving, at the remote device from a second electronic application, second interaction data associated with the user and the entity, the second interaction data indicating an interaction between the user and the entity; determining that the user review of the entity is authentic based on a classification model, the first interaction data and the second interaction data being input to the classification model; upon determining that the user review of the entity is authentic, storing, by the remote device, the user review in a data storage associated with the entity.

In some aspects, the techniques described herein relate to a non-transitory computer-readable medium including instructions for recordation of interaction data, the instructions executable by at least one processor of a remote device to perform operations, including: causing, at the remote device, a first electronic application operating on a user device to detect an interaction between a user of the user device and an entity via a second electronic application; determining that the interaction between the user and the entity reviewable based on first interaction data; upon determining that the interaction between the user and the entity is reviewable, causing the first electronic application to prompt the user to enter second interaction data including a user review of the entity associated with the detected interaction; receiving, at the remote device and from the user device, the second interaction data including the user review of the entity; determining that the user review of the entity is authentic based on a classification model, the first interaction data and the second interaction data being input to the classification model; upon determining that the user review of the entity is authentic, storing, by the remote device, the user review in a data storage associated with the entity.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for data authentication, according to some embodiments of the disclosure.

FIG. 2A depicts an exemplary classification platform, according to some embodiments of the disclosure.

FIG. 2B depicts an exemplary machine-learning module, according to some embodiments of the disclosure.

FIG. 3 illustrates an exemplary process for data authentication, according to some embodiments of the disclosure.

FIG. 4 shows an exemplary machine-learning training flow chart, according to some embodiments of the disclosure.

FIG. 5 is a functional block diagram of a computer, according to exemplary embodiments of the present disclosure.

### DETAILED DESCRIPTION OF EMBODIMENTS

According to certain aspects of the disclosure, methods and systems are disclosed for prompting and authenticating data (e.g., user reviews). Current channels for providing reviews, primarily provided by third parties unassociated with the entities being reviewed and unable to access information to authenticate a user interaction with the entity, may have insufficient options available for authenticating interactions. Accordingly, improvements in technology relating to review generation and authentication are needed.

As will be discussed in more detail below, in various embodiments, systems and methods are described for using machine learning to determine the authenticity of a review. By training a machine-learning model, e.g., via supervised or semi-supervised learning, to learn associations between item and/or entity data and corresponding user interactions with the item and/or entity, the trained machine-learning model may be usable to accurately classify interactions as authentic.

As one skilled in the art will appreciate in light of this disclosure, certain embodiments may be capable of achieving certain advantages, including some or all of the following: (1) improving the functionality of a computing system through a more streamlined communication interface for generating and analyzing reviews; (2) improving the user experience in interacting with a computer system by providing the streamlined communication interface for generating reviews; and (3) improving the reliability of information in a database by using machine-learning techniques to authenticate the validity of user reviews. In the following discussion, a general description of the system and its components is provided, followed by a discussion of the operation of the same.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or item that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, product, or the like having ownership or other rights that may be transferred. As used herein, terms like “user” or “customer” generally encompass any person or entity that may desire information, resolution of an issue, purchase of an item, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a computer-based process that classifies reviews using a first electronic application and a second electronic application on a user's device is provided. The first electronic application collects data stored on a memory of the user's device, such as HyperText Markup Language (HTML) code, metadata, or item tags. The second electronic application prompts the user for further information relating to a review, such as items purchased, sentiment, and a rating, etc. A machine learning model scores and ranks potential review classifications based on this data and user behavior. The machine learning model determines a classification for the review as authentic or fraudulent. The second electronic application then sends the classification results to a remote server.

While the examples above involve review classification, it should be understood that techniques according to this disclosure may be adapted to any suitable type of data suitable for classification. It should also be understood that the examples above are illustrative only. The techniques and technologies of this disclosure may be adapted to any suitable activity.

Presented below are various aspects of machine learning techniques that may be adapted to classification. As will be discussed in more detail below, machine learning techniques adapted to classification of reviews based on website and/or item data may include one or more aspects according to this disclosure. For example, the machine learning techniques may include a particular selection of training data, a particular training process for the machine-learning model, operation of a particular device suitable for use with the trained machine-learning model, operation of the machine-learning model in conjunction with particular data, or modification of such particular data by the machine-learning model, etc. The machine learning techniques adapted to classification of reviews may further include other aspects that may be apparent to one of ordinary skill in the art based on this disclosure.

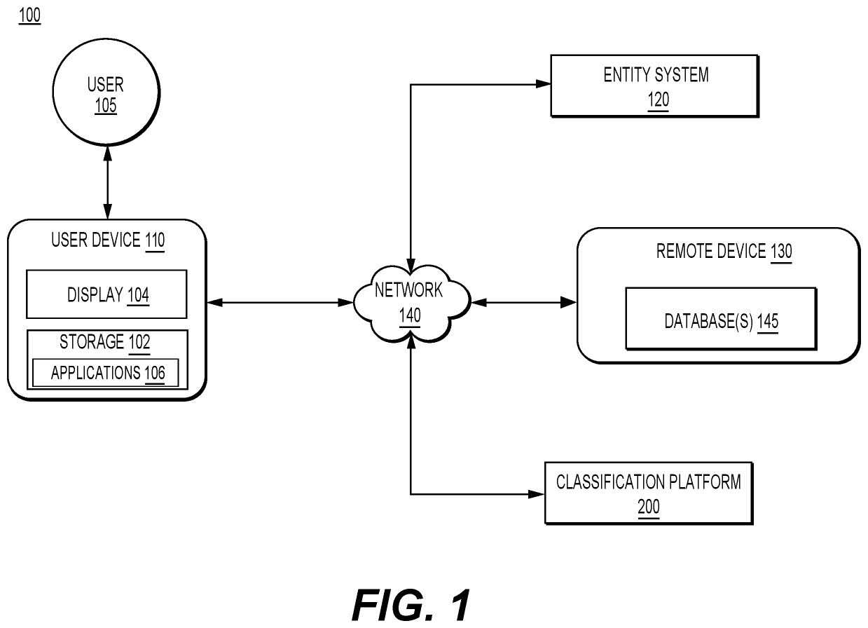

FIG. 1 depicts an exemplary environment 100 that may be utilized with techniques presented herein. One or more user device(s) 110, entity system 120, remote device 130, or the like, may communicate across an electronic network 140. As will be discussed in further detail below, one or more classification platform(s) 200 may communicate with one or more of the other components of the environment 100 across electronic network 140. The one or more user device(s) 110 may be associated with a user 105, e.g., a user associated with one or more of an interaction with an entity and providing a user review of the entity or an item associated with an interaction with an entity.

In some embodiments, one or more components of the environment 100 are associated with a common entity, e.g., a financial institution, interaction processor, merchant, or the like. In some embodiments, one or more of the components of the environment is associated with a different entity than another. For example, the first electronic application (e.g., which collects data stored on a memory of the user's device, such as HyperText Markup Language (HTML) code, metadata, or item tags), the remote device, and the classification platform may be associated with a financial institution, while the second electronic application (which prompts the user for further information relating to a review, such as items purchased, sentiment, and a rating, etc.) and the entity system 120 are associated with a merchant. The systems and devices of the environment 100 may communicate in a number of arrangements. As will be discussed herein, systems and/or devices of the environment 100 may communicate in order to one or more of generate, train, or use a machine-learning model for generation and classification of user reviews, among other activities.

The user device 110 may be configured to enable the user 105 to access and/or interact with other systems in the environment 100. For example, the user device 110 may be a computer system such as, for example, a desktop computer, a mobile device, a tablet, etc. In some embodiments, the user device 110 may include one or more electronic application(s) 106, such as first and second applications, e.g., a program, plugin, browser extension, etc., installed on a storage 102 of the user device 110. The user device 110 may further include a display 104 enabling the user 105 to access and/or interact with the user device 110. In some embodiments, the electronic application(s) 106 may be associated with one or more of the other components in the environment 100. For example, the electronic application(s) may include one or more of system control software, system monitoring software, software development tools, etc.

As noted herein, user device 110 may include first and second electronic applications 106 that allow the user 105 to access and interact with the entity system 120, the remote device 130, or other components in the environment 100. The first electronic application may be, for example, a mobile application, a program, plugin, browser extension, etc. associated and in communication with a financial institution. In some examples, the financial institution may be associated with an account of user 105 such that, upon use of an account instrument to execute an interaction, the financial institution may be requested to authorize the interaction between the user 105 and the entity associated with the entity system 120. For example, a user 105 may be purchasing goods or services from the entity, whether in-person or online, and the financial institution may be authorizing the purchase. The second electronic application may be, for example, a mobile application, a program, plugin, browser extension, etc. associated and in communication with the entity system 120. The first electronic application may provide data associated with the user 105 from the financial institution to the classification platform 200, including any authorized charges associated with an interaction with the entity system 120. The second electronic application provides data associated with user's interaction with the entity system 120 to the classification platform 200, such as items viewed, items purchased, etc.

The first and second electronic applications 106 may communicate with the classification platform 200 to provide or receive information related to interaction data. In some embodiments, the first electronic application may provide the interaction data via HTML code, metadata, or other structured data formats.

The remote device 130 may include financial services data stored in database(s) 145 related to interactions, user accounts, or other financial activities. The remote device 130 may interact with the classification platform 200 to exchange data for the purpose of analyzing interaction patterns, generating insights, or providing authentication data for authenticating reviews generated on the first electronic application.

The financial services data stored in the database(s) 145 may include various types of information related to the financial activities, profiles, or accounts of users. This data may include user profiles, interaction details, account balances, credit scores, and other relevant financial information associated with a user. User profiles may consist of personal information, such as name, address, contact details, or financial account numbers, as well as preferences and settings related to the user's financial services.

Interaction data within the financial services data may comprise a comprehensive record of the user's financial activities, including purchase history, payments, deposits, withdrawals, transfers, and other interactions associated with their accounts. This interaction data can provide one or more insights into the user's spending habits, preferences, or financial behaviors, enabling the remote device 130 to offer targeted prompts for reviews of detected interactions.

As discussed in further detail below, the classification platform 200 may one or more of (i) generate, store, train, or use a machine-learning model configured to find associations between user interactions with entities and authenticity of user reviews. The classification platform 200 may include a machine-learning model and/or instructions associated with the machine-learning model, e.g., instructions for generating a machine-learning model, training the machine-learning model, using the machine-learning model, etc. The classification platform 200 may include instructions for retrieving classification data, adjusting classification data, e.g., based on the output of the machine-learning model, and/or operating the display 104 to output classification data, e.g., as adjusted based on the machine-learning model. The classification platform 200 may include training data, e.g., item data, and may include ground truth, e.g., classification data.

In some embodiments, a system or device other than the classification platform 200 is used to generate and/or train the machine-learning model. For example, such a system may include instructions for generating the machine-learning model, the training data and ground truth, and/or instructions for training the machine-learning model. A resulting trained-machine-learning model may then be provided to the classification platform 200.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between item and/or merchant data and classification data, such that the trained machine-learning model is configured to determine an output classification in response to the input item and/or merchant data based on the learned associations.

In some embodiments, distributed learning approaches such as federated learning enable collaboration among multiple clients while maintaining privacy by performing training on decentralized devices. In some instances, different samples of training data and/or input data may not be independent. Thus, in some embodiments, the machine-learning model may be configured to account for and/or determine relationships between multiple samples.

For example, in some embodiments, the machine-learning model of the classification platform 200 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account.

In various embodiments, the electronic network 140 may be a wide area network (“WAN”), a local area network (“LAN”), personal area network (“PAN”), or the like. In some embodiments, electronic network 140 includes the Internet, and information and data provided between various systems occur online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

In some embodiments, the environment 100 may include additional components or systems that interact with the classification platform 200 or other components in the environment. These additional components may provide supplemental data, services, or functionality to support the classification process or to enhance the user experience.

Although depicted as separate components in FIG. 1, it should be understood that a component or portion of a component in the environment 100 may, in some embodiments, be integrated with or incorporated into one or more other components. For example, the classification platform 200 may be integrated into the first electronic application, the user device 110, or the like. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized for classification are discussed in further detail in the methods below. In the following methods, various acts may be described as performed or executed by a component from FIG. 1, for example, the user device 110, the first and second electronic applications 106, the remote device 130, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

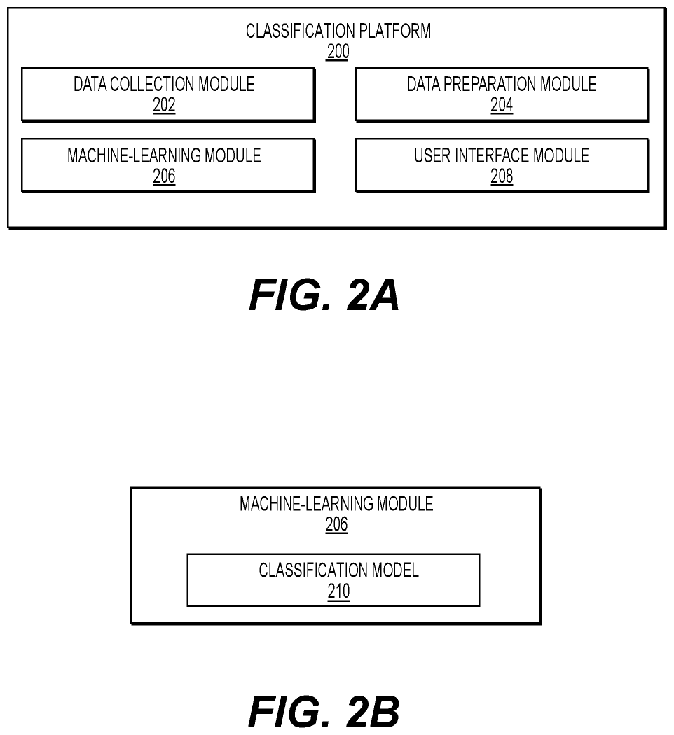

FIG. 2A illustrates an exemplary classification platform 200, which may be associated with or integrated into the first electronic application, and utilized for processing and classifying review and interaction data related to one or more items and/or entities. The classification platform 200 includes various components that work together to intake, process, and classify data obtained during a user session, such as data scraped from a browser page associated with a merchant or an item. For example, the classification platform may include a data collection module 202, a data preparation module 204, a machine-learning module 206, and a user interface module 208.

The data collection module 202 is responsible for gathering the interaction data during a user session. The user session involves interaction with first and second electronic applications 106, both of which provide data to the data collection module 202. In some examples, the first electronic application is associated with a first entity and the second electronic application is associated with a second entity. The first entity may be, for example, a financial institution and the second entity may be, for example, a merchant. The first electronic application provides data associated with the user 105 from the financial institution, including any authorized charges associated with an interaction with the second entity. The second electronic application provides data associated with user's interaction with the second entity, such as items viewed, items purchased, etc.

The data collection module 202 may be configured for scraping a browser page or obtaining data directly from the entity system 120 associated with the second entity (e.g., a merchant). The collected data may include item descriptions, HTML meta tags, keywords, and other relevant information associated with the item or merchant. The data may further include one or more transaction receipts associated with a financial system, such as a receipt associated with one or more user accounts. The receipt may include data such as purchase date and time, item description, price, total cost, payment method, merchant information transaction identifier, user information, or other information which may be relevant to the transaction.

The first electronic application may also provide data associated with a user review of the second entity. Upon detecting an interaction between the user and the second entity via the second electronic application, the first electronic application may include a prompt to the user to provide a review related to the second entity.

Once the data collection module 202 has gathered data, the data preparation module 204 processes and prepares the data for analysis by the machine-learning module 206. The data preparation module 204 may involve cleaning the data, removing irrelevant or redundant information, and converting the data into a suitable format for further processing by the machine-learning module 206.

The machine-learning module 206 receives the prepared data from the data preparation module 204 and applies machine learning algorithms and models to classify the review based on data prepared by the data preparation module 204. The machine-learning module 206 may use various training mechanisms such as supervised learning, unsupervised learning, or reinforcement learning, and may utilize a variety of models, including neural networks, decision trees, or support vector machines, to accomplish its task.

FIG. 2B presents a more detailed view of the machine-learning module 206 and its relationship with a classification model 210, which classifies reviews as authentic or suspected to be fraudulent. As previously mentioned, the machine-learning module 206 applies machine learning algorithms and models to classify reviews based on the prepared input data provided by the data preparation module 204.

The machine-learning module 206 may encompass various subcomponents and processes to ensure accurate and efficient classification. One element of the machine-learning module 206 is the classification model 210, which serves as the computational model responsible for making predictions and classifications based on the input data. The classification model 210 may be a pre-trained model or a model specifically designed and trained for the task of classifying reviews within the given context.

The development of the classification model 210 may involve multiple steps, including feature extraction, model selection, training, validation, and evaluation. Feature extraction is the process of identifying and extracting relevant features from the prepared data, which will be used as input for the classification model 210. These features may include textual information from item descriptions, keywords, HTML meta tags, or any other relevant data points that can aid in the classification process.

Model selection is the process of choosing the most suitable machine learning algorithm or model for the classification task. This may involve comparing various algorithms such as decision trees, support vector machines, neural networks, or ensemble methods, and selecting the one that provides the best performance based on predefined criteria, such as accuracy or computational efficiency.

The classification model 210 may be trained using a dataset that includes both input features and corresponding ground truth labels. The training process involves adjusting the model's parameters to minimize the error between the model's predictions and the ground truth labels. This process may include using techniques such as gradient descent, backpropagation, or other optimization algorithms. In some examples, semi-supervised or unsupervised training may be used.

After the training process, the classification model 210 may be validated and evaluated using a separate dataset not used during training. This allows for an assessment of the model's performance on unseen data, providing insights into its generalization capabilities and ensuring that it can accurately classify reviews in real-world scenarios.

The classification model 210 may be integrated into the machine-learning module 206, which then utilizes the model to make predictions and classifications based on the prepared input data. The results generated by the classification model 210 are then transmitted to the user interface module 208 for presentation to the user, as previously discussed. The machine-learning module 206 and/or the submodels thereof (e.g., classification model 210) may also be stored elsewhere and be accessible to the classification platform 200.

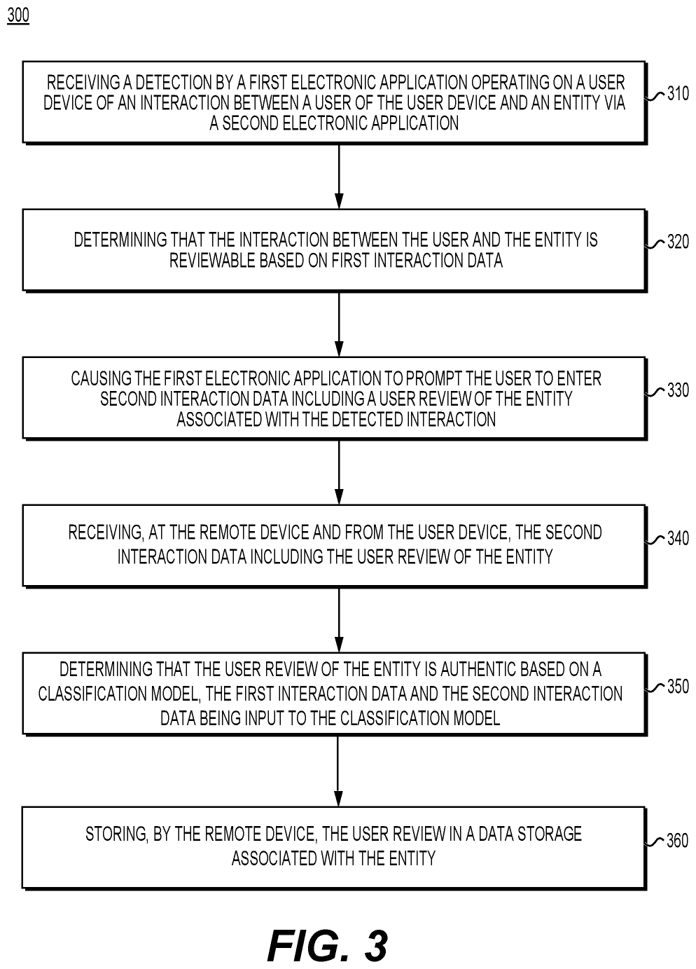

FIG. 3 illustrates an exemplary process 300 for review generation and authentication, according to some embodiments of the disclosure.

At step 320, the process 300 includes receiving, at the remote device 130, a detection by the first electronic application operating on the user device 110, an interaction between a user 105 of the user device 110 and an entity via a second electronic application.

In some examples, the remote device 130 and the first electronic application may be associated with a first entity such as a financial institution, and the second electronic application may be associated with a second entity, such as a merchant providing goods or services. The interaction between the user 105 and the entity may be, for example, the purchase of an item or a payment for services rendered. The interaction may be performed, for example, at a point-of-sale (POS) device. The first electronic application may detect the interaction by identifying a charge on an account or transaction card associated with the user 105 and the financial institution, where the financial institution may be a bank or credit card issuing company. The interaction data may include: (i) identification of items exchanged in the interaction, such as goods purchased; (ii) a merchant category code (MCC) for the entity; (iii) valuations of the items exchanged in the interaction; or (iv) geo-location data of the entity.

The first electronic application may also retrieve data from database(s) 145 associated with the financial institution that may include other data regarding the user 105, the merchant, or previous interactions between the user and the merchant. For example, the data may further include a frequency of purchases made at the merchant by the user, values of purchases made by the user at the merchant, etc. The database(s) 145 may also include information related to reviews for the merchant, including demographic information about the user 105 and other reviewers, how frequently the merchant is reviewed, etc.

At step 320, the process 300 includes determining that the interaction between the user and the entity is reviewable based on first interaction data gathered at step 310. This may include determining the entity is an entity for which reviews are applicable. For example, if the database(s) 145 include reviews for the entity, then it would be determined that the entity is an entity for which reviews are applicable. If there are no reviews for the entity in the database(s) 145, but other entities with, for example, similar MCC codes have reviews, then it may be determined that the entity is an entity for which reviews are applicable. In some other examples, it may be determined that the item that the user 105 purchased from the entity is an item that is regularly reviewed. If so, then it may be determined that the entity is an entity for which reviews are applicable. As such, determining the entity is an entity for which reviews are applicable comprises inputting the first interaction data into a rule-based algorithm, the algorithm including inputs such as MCC codes, reviews for items purchased or services rendered at or by the entity, and other factors.

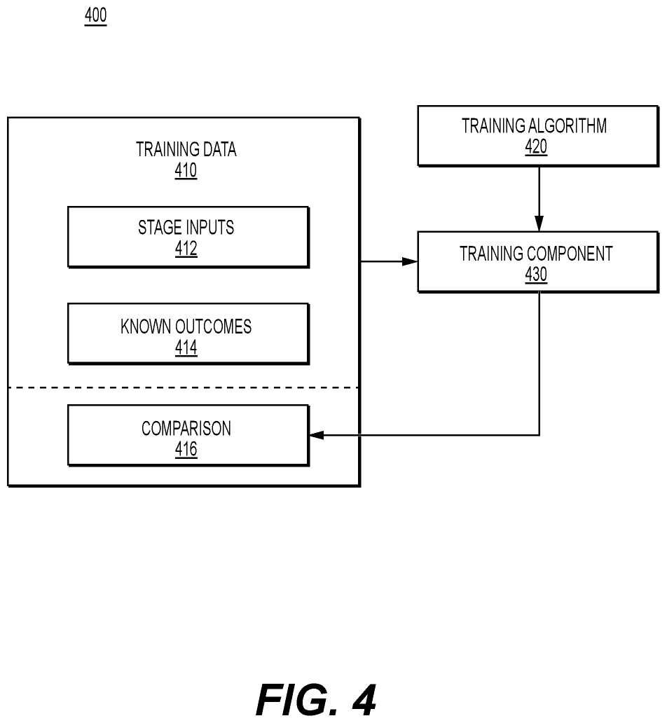

Further, the step 320 may optionally include determining that the user would be likely to leave a review if prompted. This includes determining that user interest of the user for submission of the review exceeds a predetermined threshold. Many factors may influence a user's decision to leave a review if prompted. These factors may include, for example, the user's frequency of past reviews, the user's responsiveness to prior prompts to leave a review, the user's demographic information, such as age, geo-location, etc. Determining that the user interest of the user for submission of the review exceeds the threshold may comprise inputting the first interaction data into a trained machine learning model, as described in FIG. 4.

At step 330, upon determining that the interaction between the user and the entity is reviewable, and optionally, upon determining that the user is likely to leave a review if prompted, the process 300 includes causing the first electronic application to prompt the user to enter second interaction data including a user review of the entity associated with the detected interaction. This may be done in a manner to maximize the likelihood that the user would leave a review. For example, the step of causing the first electronic application to prompt the user to enter second interaction data may be performed a predetermined time after the detected interaction, the predetermined time being based on the interaction data. For example, it may be determined that a user is most likely to leave a review an hour, a day, or a week after the interaction. Furthermore, these time intervals may be dependent on the type of merchant or the type of product or service acquired. For example, a user may be more likely to leave a review for a convenience store or fast food restaurant an hour after the interaction, while more likely to leave a review for a hotel a day after the interaction, and more likely to leave a review for a seller of luxury goods a week after the interaction. Furthermore, it may be determined that a user is more likely to review a luxury good or expensive item, while the user is less likely to review a disposable item or relatively inexpensive item. The thresholds for what constitute expensive items may be determined by the machine-learning model and may include as inputs the user's purchase histories, spending habits, etc. An item that may be determined to be expensive for one user may not be determined to be expensive for another user, and thus the determinations as to what items, services, or merchants that are reviewable to one user may differ from the items, services, or merchants that are determined to be reviewable to a different user.

At step 340, the process 300 includes receiving, at the remote device 130 and from the user device 110, the second interaction data including the user review of the entity. The user review may include, for example, items purchased, sentiment, and a star or other scale rating. At step 350, the process 300 further includes determining that the user review of the entity is authentic based on the classification model 210, the first interaction data and the second interaction data being input to the classification model 210. The classification model 210, as described in FIG. 2B, classifies reviews as authentic or suspected to be fraudulent. More detail regarding training the model are described with respect to FIG. 4.

At step 360, upon determining that the user review of the entity is authentic, the process 300 proceeds to storing, by the remote device 130, the user review in a database(s) 145. The database(s) 145 may be associated with the entity, the financial institution, or may be associated with a digital channel, such as an external review website. To further incentivize reviews and maintain the robustness of the review process, the user 105 may receive validation for completing the review. Optionally, the process 300 may include displaying the user review via the display 104 and prompting the user for feedback that is received by the classification model 210.

One or more implementations disclosed herein include and/or are implemented using a machine-learning model, such as the classification model 210 described in the context of the present discussion. For example, one or more of the modules of the classification platform are implemented using a machine-learning model and/or are used to train the machine-learning model. FIG. 4 shows an example machine-learning training flow chart 400, according to some embodiments of the disclosure. Referring to FIG. 4, a given machine-learning model is trained using the training flow chart 400. The training data 410 includes one or more of stage inputs 412 and the known outcomes 414 related to the machine-learning model to be trained. The stage inputs 412 are from any applicable source, including text, visual representations, data, values, comparisons, and stage outputs, e.g., one or more outputs from one or more steps from FIG. 3. The known outcomes 414 are included for the machine-learning models generated based on supervised or semi-supervised training or can be based on known labels, such as review classification labels. An unsupervised machine-learning model is not trained using the known outcomes 414. The known outcomes 414 include known or desired outputs for future inputs similar to or in the same category as the stage inputs 412 that do not have corresponding known outputs.

The training data 410 and a training algorithm 420, e.g., one or more of the modules implemented using the machine-learning model and/or used to train the machine-learning model, are provided to a training component 430 that applies the training data 410 to the training algorithm 420 to generate the machine-learning model. According to an implementation, the training component 430 is provided with comparison results 416 that compare a previous output of the corresponding machine-learning model to apply the previous result to re-train the machine-learning model. The comparison results 416 are used by the training component 430 to update the corresponding machine-learning model. The training algorithm 420 utilizes machine-learning networks and/or models including, but not limited to, deep learning networks such as Deep Neural Networks (DNN), Convolutional Neural Networks (CNN), Fully Convolutional Networks (FCN), and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The training data 410 may include a human labeled data set of real and fabricated reviews with further information about the reviews related to parameters such as: similarity of the review to existing reviews, with greater similarity scoring as more fraudulent; items purchased being present in the review, weighting the review as more authentic; time of purchase with reference to business hours, with purchases outside of business hours weighted toward fraudulent; the amount of time spent drafting a review, with a very fast review weighted toward fraudulent as, e.g., suspected bot activity; number of times the reviewer has made a purchase at a particular merchant, with a greater number weighing toward authenticity; the time between purchase and review submission; extreme positive or negative sentiment; the review being semantically unrelated to the goods or services being sold; addition of media such as photos and videos weighing toward authentic; number of other reviews completed, with a higher number weighing toward authentic; and number of past reviews attempted that were contested or found irrelevant or otherwise deemed fraudulent, weighing the review toward fraudulent. The threshold for classification may be determined or tuned to balance tradeoffs between false positives and negatives.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data and/or input data. The resulting outputs are adjusted based on the adjusted weights and/or layers.

The initial training of the machine-learning model for review classification may be completed by utilizing review data that has been tagged as possible fraudulent or likely authentic. In some embodiments, this tagged data serves as an input for supervised or semi-supervised learning approaches. The tagging process can be done manually or automatically, depending on the desired level of accuracy and available resources.

Manual tagging involves human annotators who examine reviews and assign appropriate classification labels based on the content and context of the review. This method can yield high-quality labeled data, as humans can understand nuances and contextual information better than automated algorithms. However, manual tagging can be time-consuming and labor-intensive, especially when dealing with large datasets.

Automatic tagging, on the other hand, involves using algorithms, such as natural language processing techniques or pre-trained machine-learning models, to assign classification labels to reviews. This approach is faster and more scalable than manual tagging but may not be as accurate, particularly when dealing with complex or ambiguous items. To improve the accuracy of automatic tagging, it can be combined with manual tagging in a semi-supervised learning approach, where a smaller set of manually tagged data is used to guide the automatic tagging process.

The data collection process can be done manually or using web-scraping techniques. Manual data collection involves browsing websites and gathering review data information, which can be time-consuming and may not cover all the available review websites on the internet. Web-scraping techniques, on the other hand, use automated tools and scripts to extract reviews from various sources, making the process faster and more comprehensive.

Once the review data has been collected and tagged with appropriate classification labels, it can be used as input for the machine-learning model's training process. The model will learn to recognize patterns and features in the data that correspond to specific authentic or fraudulent reviews. With sufficient training and accurate labeled data, the machine-learning model can become adept at classifying new reviews, enabling an efficient and effective review classification system.

In some embodiments, one or more additional sources of data are utilized for training data. For example, customer receipts may be utilized as source data, either alone or in combination with review data associated with one or more entities. The customer receipts may be accessed by the system either through scanning of physical receipts, or from data associated with one or more user account, such as a transaction record within the user account (which may be considered an electronic receipt, in some embodiments). The transaction record may include data associated with one or more transaction, each transaction associated with one or more items, and each item associated with one or more merchant. The association with the merchant may include, in some embodiments, association with a webpage associated with the item, such as earlier described. Data about the transaction may include item names, merchant and/or item categories, timestamps, prices, locations, and other data typically associated with transactions.

As one skilled in the art will appreciate in light of this disclosure, certain embodiments may be capable of achieving certain advantages, including some or all of the following: (1) improving the functionality of a computing system through a more streamlined communication interface for generating and analyzing reviews; (2) improving the user experience in interacting with a computer system by providing the streamlined communication interface for generating reviews; and (3) improving the reliability of information in a database by using machine-learning techniques to authenticate the validity of user reviews.

It should be understood that embodiments in this disclosure are exemplary only, and that other embodiments may include various combinations of features from other embodiments, as well as additional or fewer features.

In general, any process or operation discussed in this disclosure that is understood to be computer-implementable, such as the processes illustrated in FIGS. 2A-4, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices to perform a computer-implemented method. A memory of the computer system may include the respective memory of each computing device of the plurality of computing devices.

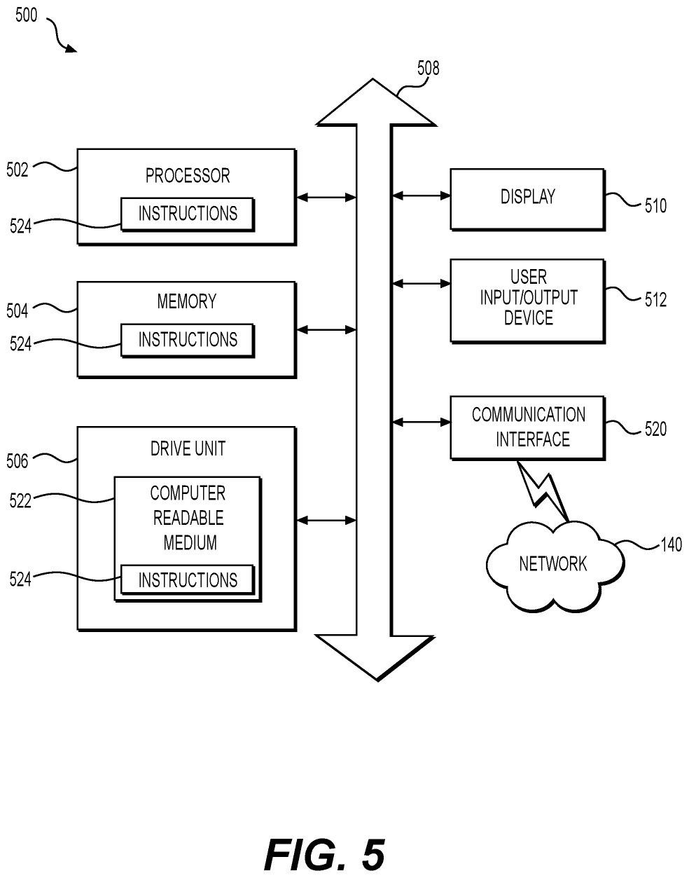

FIG. 5 is a simplified functional block diagram of a computer 500 that may be configured as a device for executing the methods of FIGS. 2A-4, according to exemplary embodiments of the present disclosure. For example, the computer 500 may be configured as the classification platform 200 and/or another system according to exemplary embodiments of this disclosure. In various embodiments, any of the systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 and/or computer readable medium 522). The computer 500 also may include input and output ports 512 and/or a display 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “items” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method, comprising:
receiving, at a remote device, a detection by a first electronic application operating on a user device of an interaction between a user of the user device and an entity via a second electronic application;
determining that the interaction between the user and the entity is reviewable based on first interaction data;
upon determining that the interaction between the user and the entity is reviewable, causing the first electronic application to prompt the user to enter second interaction data including a user review of the entity associated with the detected interaction;
receiving, at the remote device and from the user device, the second interaction data including the user review of the entity;
determining that the user review of the entity is authentic based on a classification model, the first interaction data and the second interaction data being input to the classification model;
upon determining that the user review of the entity is authentic, storing, by the remote device, the user review in a data storage associated with the entity.

2. The method of claim 1, wherein determining that the interaction between the user and the entity is reviewable comprises:
determining the entity is an entity for which reviews are applicable; and
determining that user interest of the user for submission of the review exceeds a threshold.

3. The method of claim 2, wherein:
determining the entity is an entity that for which reviews are applicable comprises inputting the first interaction data into a rule-based algorithm.

4. The method of claim 2, wherein:
determining that the user interest of the user for submission of the review exceeds the threshold comprises inputting the first interaction data into a trained machine learning model.

5. The method of claim 1, wherein the first interaction data includes at least one of: (i) identification of items exchanged in the interaction; (ii) a merchant category code (MCC) for the entity; (iii) valuations of the items exchanged in the interaction; or (iv) geo-location data of the entity.

6. The method of claim 1, wherein causing the first electronic application to prompt the user to enter second interaction data is performed a predetermined time after the detected interaction.

7. The method of claim 6, wherein the predetermined time is determined based on the first interaction data.

8. The method of claim 1, wherein the interaction occurs at a point-of-sale (POS) device remote from the user device.

9. The method of claim 1, wherein the classification model is a trained machine learning model.

10. The method of claim 1, wherein upon determining that the user review of the entity is authentic, transmitting the user review to at least one digital channel.

11. A computer-implemented method, comprising:
receiving, at a remote device from a first electronic application, first interaction data associated with a user and an entity, the first interaction data including a user review of the entity;
retrieving, at the remote device from a second electronic application, second interaction data associated with the user and the entity, the second interaction data indicating an interaction between the user and the entity;
determining that the user review of the entity is authentic based on a classification model, the first interaction data and the second interaction data being input to the classification model;
upon determining that the user review of the entity is authentic, storing, by the remote device, the user review in a data storage associated with the entity.

12. The method of claim 11, wherein the first electronic application is a digital channel.

13. The method of claim 11, wherein the interaction occurs at a point-of-sale (POS) device remote from the user device.

14. The method of claim 11, wherein the classification model is a trained machine learning model.

15. The method of claim 11, wherein upon determining that the user review of the entity is authentic, transmitting the user review to at least one digital channel.

16. A non-transitory computer-readable medium comprising instructions for recordation of interaction data, the instructions executable by at least one processor of a remote device to perform operations, including:
causing, at the remote device, a first electronic application operating on a user device to detect an interaction between a user of the user device and an entity via a second electronic application;
determining that the interaction between the user and the entity reviewable based on first interaction data;
upon determining that the interaction between the user and the entity is reviewable, causing the first electronic application to prompt the user to enter second interaction data including a user review of the entity associated with the detected interaction;
receiving, at the remote device and from the user device, the second interaction data including the user review of the entity;
determining that the user review of the entity is authentic based on a classification model, the first interaction data and the second interaction data being input to the classification model;
upon determining that the user review of the entity is authentic, storing, by the remote device, the user review in a data storage associated with the entity.

17. The non-transitory computer-readable medium of claim 16, wherein determining that the interaction between the user and the entity is available for review comprises:
determining the entity is an entity for which reviews are applicable; and
determining that user interest of the user for submission of the review exceeds a threshold.

18. The non-transitory computer-readable medium of claim 17, wherein:
determining the entity is an entity for which reviews are applicable comprises inputting the first interaction data into a rule-based algorithm.

19. The non-transitory computer-readable medium of claim 17, wherein:
determining that user interest of the user for submission of the review exceeds a threshold comprises inputting the first interaction data into a trained machine learning model.

20. The non-transitory computer-readable medium of claim 16, wherein the first interaction data includes at least one of: (i) identification of items exchanged in the interaction; (ii) a merchant category code (MCC) for the entity; (iii) valuations of the items exchanged in the interaction; or (iv) geo-location data of the entity.
